(19) United States
(12) Patent Application Publication
(10) Pub. No.: US 2016/0318058 A1
(43) Pub. Date: Nov. 3, 2016

(54) Spray Booth and Method of Operation

(71) Applicant: Jean Naim, Toronto (CA)

(72) Inventor: Jean Naim, Toronto (CA)

(21) Appl. No.: 15/208,988

(22) Filed: Jul. 13, 2016

(51) Int. Cl. B05B 15/12; B01D 46/00

(52) U.S. Cl. CPC B05B 15/1222; B01D 46/0023

(57) ABSTRACT

A spray booth for use within a building has a metal housing that defines a partially enclosed spray zone in which a worker operates spray equipment. The spraying operation places particulates and volatiles into the air of the spray zone. A main airflow producer draws a contaminated airflow from the spray zone through a large air intake port into an air intake plenum within the housing. A conventional particulate filter mounted in the air intake port removes droplets of paint or other coating compositions from the incoming airflow. The airflow is then directed through a filter in the air intake plenum that removes most, but not all, volatiles. Most of the fully-filtered airflow is discharged back into the spray zone but a small portion is forced by an auxiliary airflow producer to points external to the building. This causes an equal flow of fresh replacement air to be drawn into the spray zone from the interior of the building and ultimately from outdoors. Volatiles in the spray zone are reduced to acceptable levels while heating and cooling costs necessitated by replacement air flows are significantly reduced.

### FIELD OF THE INVENTION

The invention relates generally to spray booths operated within a building and providing a partially enclosed spray zone in which a worker can spray paint articles. For purposes of this specification, the term “paint” should be understood as any liquid composition adapted to dry on an article to provide a protective or decorative coating, including conventional paints and lacquers, and the process of “spray painting” involves spraying such varied compositions onto article surfaces.

### DESCRIPTION OF THE PRIOR ART

Spray booths designed for use within a building are well known. In a typical configuration, the spray booth has a metal housing that defines a partially enclosed spray zone in which a worker operates spray equipment. The spray equipment commonly puts particulates, primarily small paint droplets, and volatiles, typically volatile organic compounds (VOCs), into the air within the spray zone. Such contaminants must be removed from the spray zone to avoid accumulation of potentially explosive concentrations and to avoid deleteriously affecting a worker's health. To that end, an airflow producer is commonly used to draw contaminated airflows from the spray zone through an air intake port into a plenum within the housing. The air intake port is commonly a large rectangular opening formed in a vertical housing wall that faces the spray zone. A particulate filter, commonly consisting of a metal framework that retains large rectangular filter pads, is mounted to the air intake port to remove droplets of paint from incoming air flows. The filtered airflow is then directed to a discharge port coupled by ventilating conduits, separate and distinct from spray booth itself, to points external to the building. In this process, fresh air is drawn from the interior of the building to replace the contaminated air removed from the spray zone.

Fresh air is ultimately drawn from outside the building to replace contaminated air discharged to the outdoors. Equipment may be provided to enhance inflow of replacement air from outside and may heat incoming airflows during winter months. In summer, the building's air conditioning system may cool incoming fresh air. Since the entire volume of a building may be replaced several times daily, the attendant cost of heating or cooling fresh incoming airflows can be formidable, and such inefficient operation has been accepted for decades.

### SUMMARY OF THE INVENTION

In one aspect, the invention provides a method of controlling air quality associated with a spray booth operated within a building. As in the prior art, the spray booth comprises a housing that defines a partially enclosed spray zone in which a worker operates spray equipment. As in the prior art, the spray equipment puts particulates and volatiles from paint compositions into the air of the spray zone. A flow of air is drawn from the spray zone and directed along a predetermined path extending from an air intake port to a return air port that discharges air into the spray zone. A filter assembly removes particulates from the airflow, and the particulate-filtered airflow is thereafter passed through a filter assembly adapted to remove volatiles. A minor portion of the airflow downstream from the particulate filter assembly is discharged from the housing to points external to the building. A major portion of the airflow downstream of the volatiles filter assembly is discharged through the return air port back into the spray zone.

A practical inexpensive filter for removing volatiles from spray booth airflows will typically be unable to remove all volatiles. The invention consequently requires a minor portion of the airflow drawn from the spray zone to be expelled from the building. This causes fresh air to be drawn from the interior of the building into the spray zone in direct proportion to the extent of the minor airflow, effectively diluting the concentration of volatiles in the spray zone to acceptable levels. For purposes of this specification a “minor airflow portion” should be understood as less than 50% of the airflow drawn from the spray zone. A “major airflow portion” should be understood as more than 50% of the airflow drawn from the spray zone. Observing such limits, the replacement air drawn from interior of the building and ultimately drawn from outside the building is effectively reduced by at least 50% from prior practices. This reduces the cost for heating and cooling air drawn from outside the building to very roughly half of that experienced with the prior art practices described above. How much air must be discharged from a spray operation to avoid exceeding a lower explosive limit or to reduce the concentration of toxic volatiles can be determined separately for each spray composition used. However, the inventor has noted that choosing the minor airflow to be about 10% of the total incoming airflow and the major airflow to be about 90% of the total incoming airflow is appropriate for most applications. The energy savings derived from such operation can be very significant.

Other aspects of the invention will be apparent from drawings and description relating to preferred embodiments of the invention.

### DESCRIPTION OF THE DRAWINGS

The invention will be better understood with reference to drawings, in which:

FIG. 1 is a schematic representation of a preferred embodiment of a spray booth embodying the invention;

FIG. 2 is a front view of the spray booth;

FIG. 3 is a top view of the spray booth;

FIG. 4 is a side view of the spray booth;

FIG. 5 is a perspective view of the spray booth;

FIG. 6 is a perspective view of a filter assembly that removes VOCs from airflows;

FIG. 7 is a side view of the VOC filter assembly;

FIG. 8 is a view of the filter assembly from above;

FIG. 9 is a cross-sectional view along lines 9-9 of FIG. 7; and,

FIG. 10 is a cross-sectional view in a central horizontal plane of the filtering assembly.

### DESCRIPTION OF PREFERRED EMBODIMENTS

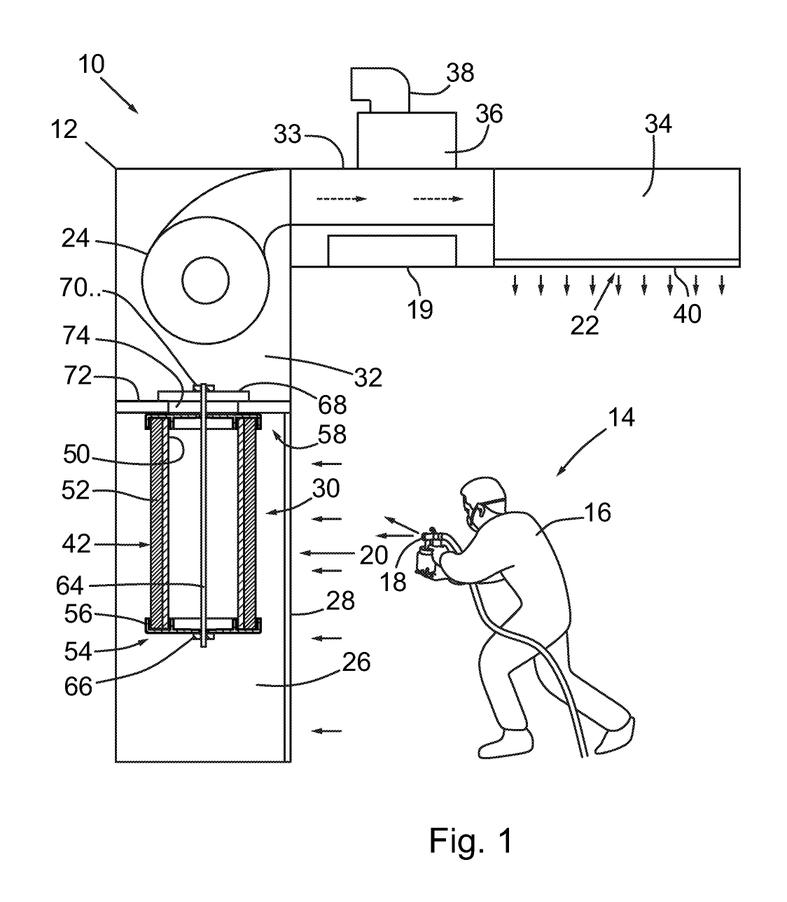

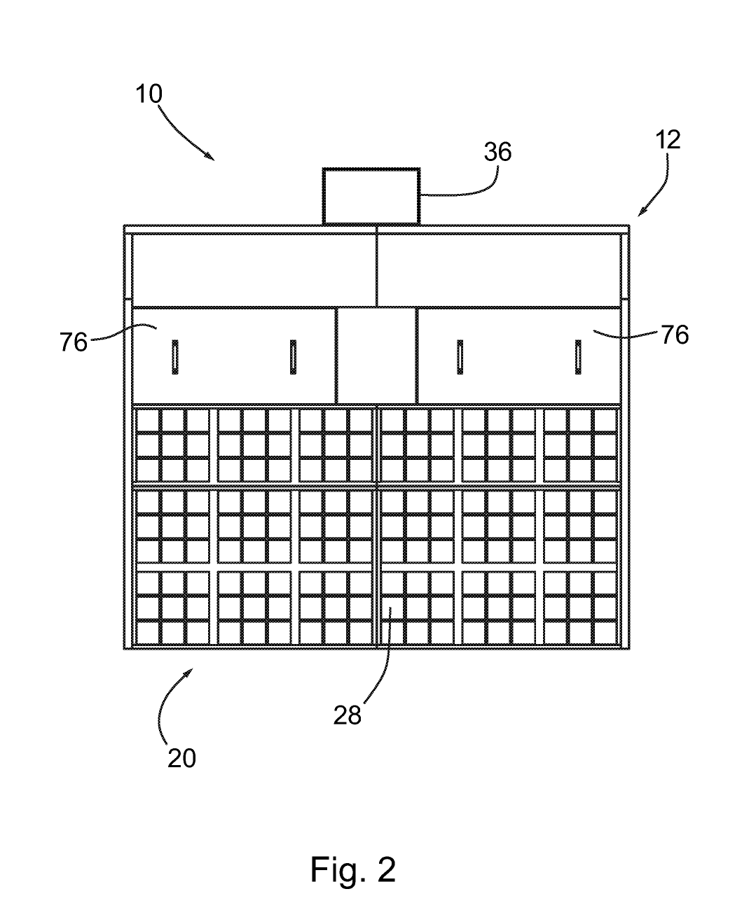

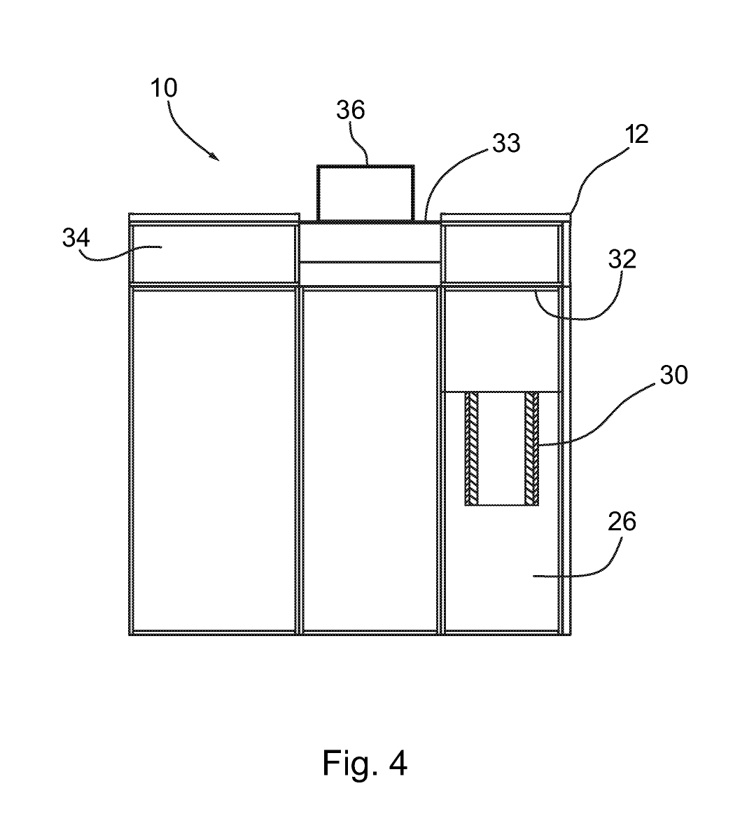

Reference is made to FIGS. 1-5 that show a spray booth 10 with a housing 12 constructed largely of sheet metal. The housing 12 defines a partially enclosed spray zone 14 closed at its sides, top, bottom and back but having an open forward face to allow access by a worker 16 (shown in FIG. 1). A portable spray gun 18 (shown in FIG. 1) may be used in the spray zone 14 to paint articles (not shown). Partial enclosure of the spray zone 14 is sufficient to contain air contaminated with particulates and volatiles for removal with airflows. Lighting fixtures 19 (apparent in FIG. 1, 3, 5) are mounted to the housing 12 to illuminate the spray zone 14. Installation and use of such lighting in spray booths is entirely conventional and will not be discussed further.

As most apparent in FIG. 1, the housing 12 defines an airflow path (defined largely by air plenums and ports) that extends from an air intake port 20 to a return air port 22. Airflows associated with the housing are indicated with arrows in FIG. 1. A main airflow producer (fan unit) 24 draws an airflow from the spray zone 14 through the air intake port 20 into an air intake plenum 26 formed in a lower portion of the housing 12. The air intake port 20 is a large rectangular opening formed, as in the prior art, in a vertical housing wall defining a rear surface of the spray zone 14. A filter assembly 28 is mounted in the air intake port 20 to remove particulates from incoming airflows. The particulate filter assembly 28 is a conventional paint arrestor grid with replaceable rectangular sheets of filtering material mounted in a metal framework, as known in prior art spray booths.

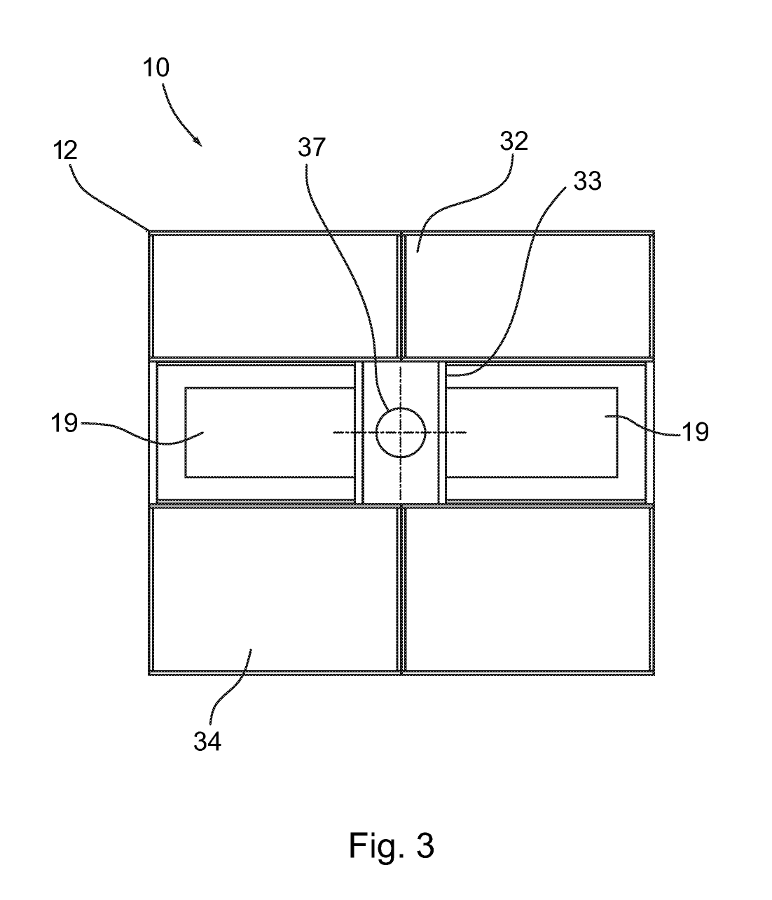

The airflow is drawn from the air intake plenum 26 through a filter assembly 30 adapted to remove VOCs and into an intermediate plenum 32 located physically above and sequentially downstream of the air intake plenum 26. The VOC filter assembly 30 is located downstream of the particulate filter assembly 28 so that paint particulates do not accumulate to a significant degree in the VOC filter assembly 30 and impair its operation. The main airflow producer 24 is operatively mounted within the intermediate plenum 32 and propels the airflow through a return air duct 33 toward a return air plenum 34 immediately above the spray zone 14. A secondary airflow producer (fan unit) 36 is mounted on the return air duct 33 and coupled to the duct 33 via a discharge port 37 (apparent in FIGS. 3 and 5 where the airflow producer 36 has been removed). The secondary airflow producer 36 diverts a minor portion of the airflow along the flow path to a discharge duct 38 leading to points external to the building in which the spray booth 10 is operated.

In a typical application, the main airflow producer 24 might be selected to draw 7000 cubic feet of air per minute through the air intake port 20. The secondary airflow producer 36 might be selected to divert a minor portion of that airflow, about 700 cubic feet per minute, for discharge from the building. Thus a major portion of the airflow, 6300 cubic feet per minute, is directed to the return air port 22 and back into the spray zone 14. Discharging the minor airflow portion to the outdoors effectively causes 700 cubic feet per minute of airflow to be drawn from the interior of the building, and ultimately from outdoors, to introduce fresh air into the spray zone 14. Since the major portion of the airflow is discharged back into the spray zone 14, heating and cooling costs are very significantly reduced.

It should be noted that the diverted minor airflow portion might be drawn from the air intake plenum 26 or any other point in the flow path downstream of the particulate filter assembly 28. The arrangement illustrated is preferred since it reduces discharge of potentially toxic volatiles from the building and makes location of a discharge outlet less critical. It is not required, however, to achieve the energy savings associated with the invention. The minor diverted airflow might also be achieved by providing an appropriate physical branch in the flow path downstream of the particulate filter assembly 28 and leading to the discharge duct 38. However, use of the secondary airflow producer 36 to divert a very specific volume of the main airflow per minute produces far more reliable results.

The filter assembly 28 tends to release particulate filtering material into the airflow. The large cross-sectional dimensions of the return air plenum 34, which extends over much of the ceiling structure of the spray zone 14, slow the major airflow portion before discharge through the return air port 22. The return air port 22 is a rectangular opening with cross-sectional dimensions corresponding to those of the return air plenum 34. The slowed airflow portion is passed through a particulate filter 40 mounted in the return air port 22. The filter assembly 40 is preferably a conventional particulate arrestor grid similar to that mounted in the air intake port 20 but oriented horizontal. Diffusion and slowing of airflow in the return air plenum 34 facilitates trapping of entrained filter particulates at the filter assembly 40 before discharge of air back to the spray zone 14.

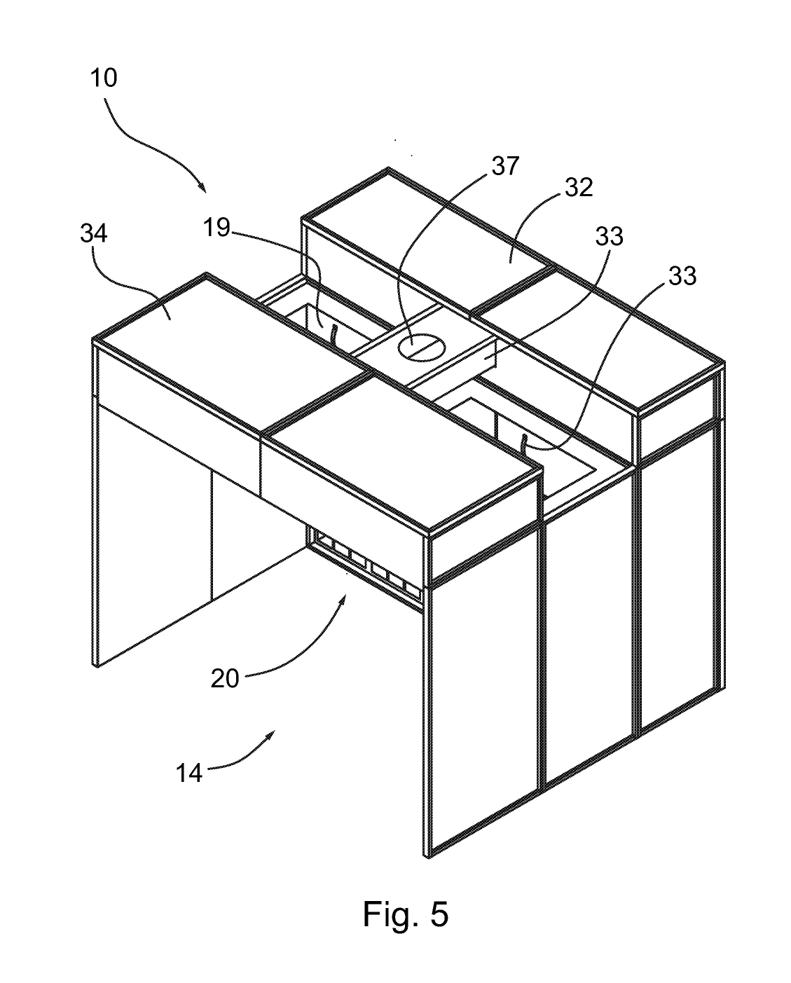

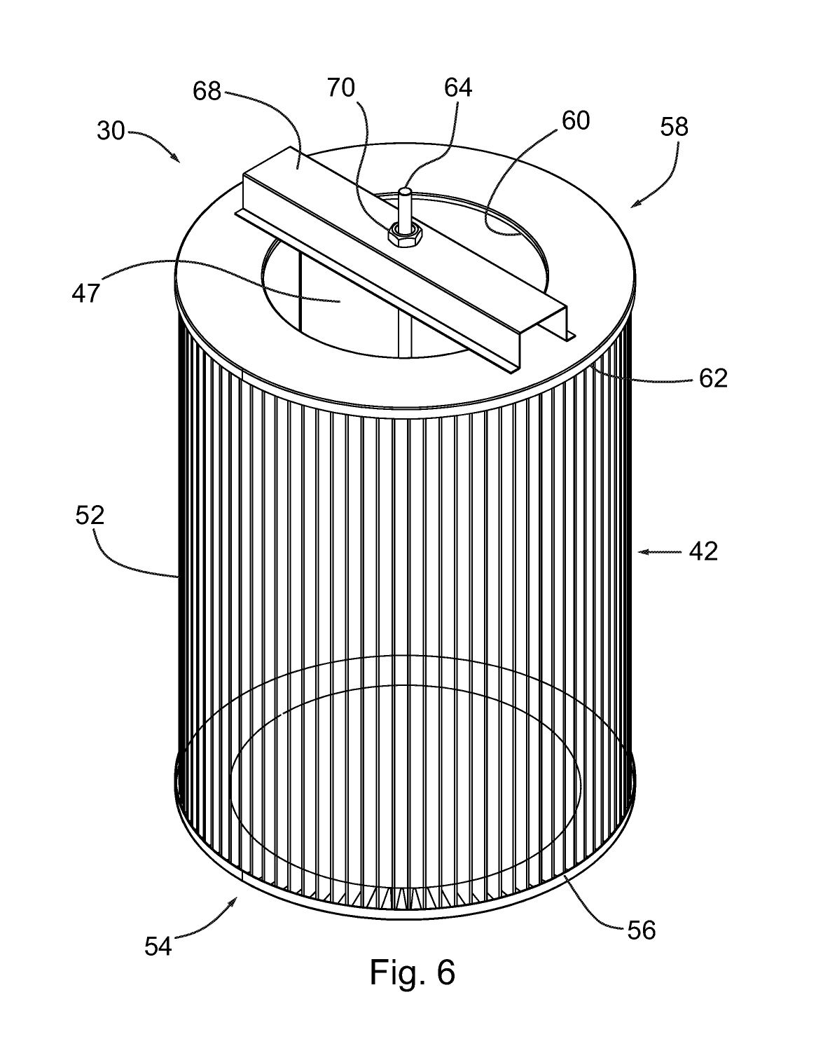

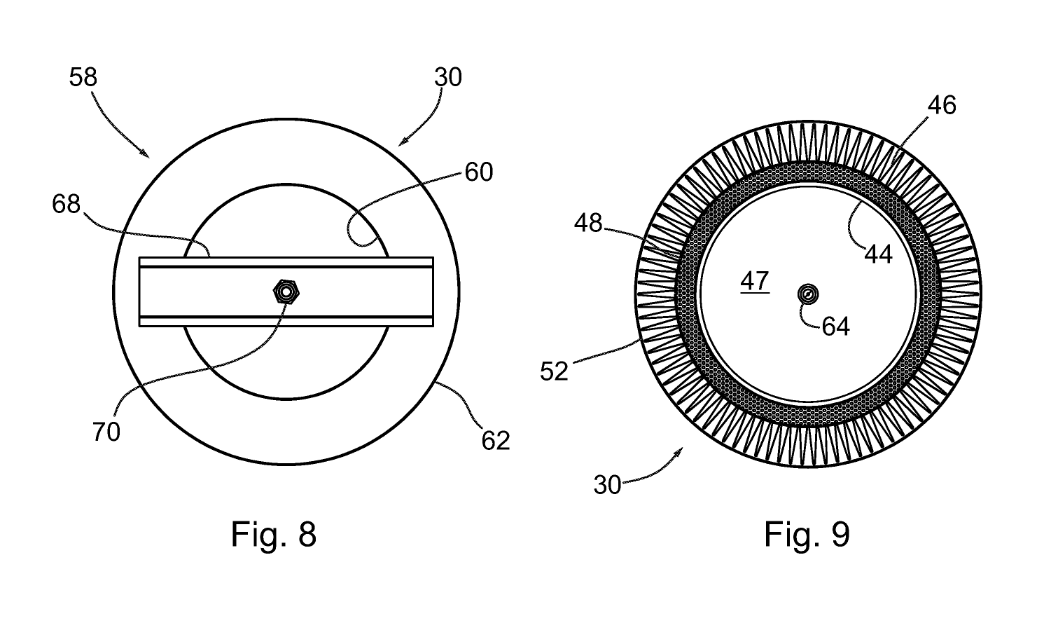

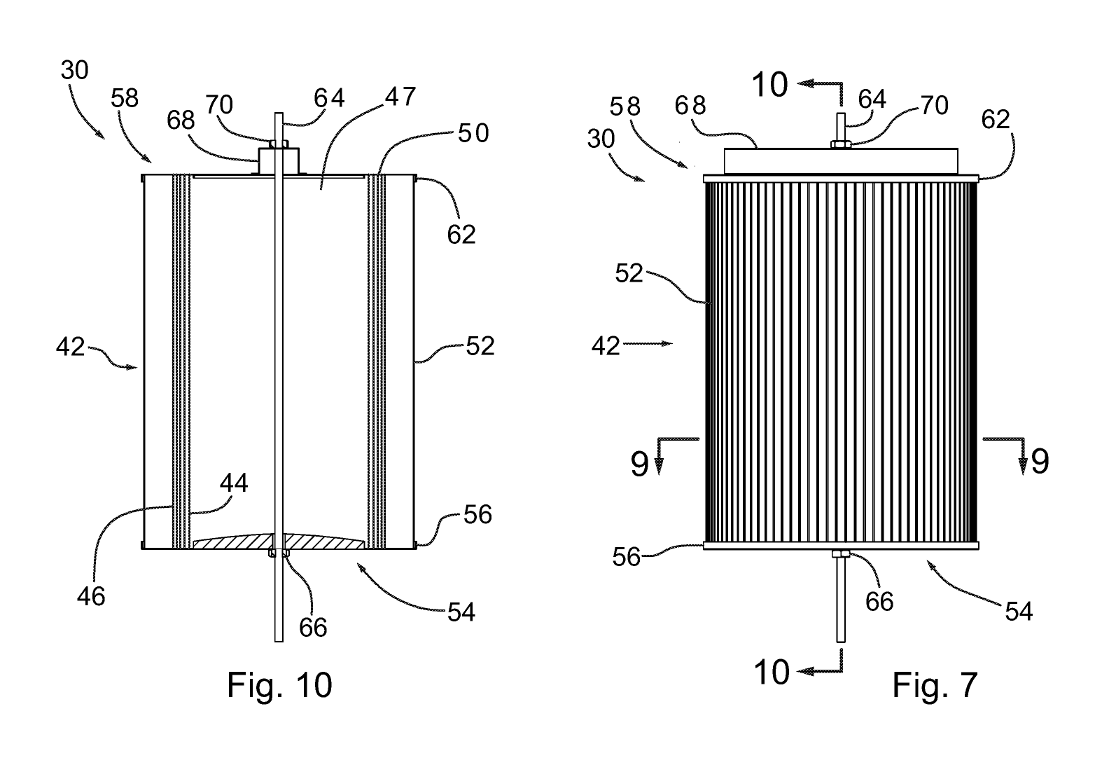

Details of the construction of the VOC filter assembly 30 are apparent in FIGS. 6-10. The VOC filter assembly 30 includes a generally cylindrical structure 42 roughly 18 inches in diameter and 24 inches in length. The structure 42 includes a pair of generally cylindrical wire mesh screens 44, 46 mounted concentrically about the central lengthwise axis of the cylindrical structure 42 and defining a central, lengthwise flow passage 47 with a diameter of about 11 inches. The inner and outer screens 44, 46 are dimensioned and spaced to define a generally cylindrical cavity 48 (indicated in FIG. 9) with a radial depth of about 1 inch. The cavity 48 is open at an upper end of the cylindrical structure 48 to receive pellets 50 of filtering material (indicated in FIG. 10). The pellets 50 comprise conventional activated carbon but any pelletized gas phase removal media known or yet to be developed might be substituted. The cylindrical structure 42 includes a high efficiency particulate air (HEPA) filter 52 formed as a corrugated cylindrical sleeve and located about the outer mesh screen 42. The filter assembly 28 at the air intake port 20 removes large particulates entrained with incoming airflows but the HEPA filter 52 ensures that fine paint droplets are removed to avoid contaminating the activated-carbon pellets 50.

The lower end of the cylindrical structure 42 is closed with a lower cap 54. The lower cap 54 is essentially a circular disk with an upwardly directed circumferential flange 56 that extends around the periphery of the cap 54. The flange 56 assists in centering the lower end of the cylindrical structure 42 relative to the lower cap 54, and during assembly, the lower ends of the two mesh screens 44, 46 and the HEPA filter 52 are glued to the upper face of the cap 54. This arrangement closes the lower end of the cavity 48 against loss of activated-carbon pellets 50 and also closes the lower end of the cylindrical structure 42, particularly its central flow passage 47, against upward airflows that are not VOC-filtered.

An annular upper cap 58 is seated on the upper end of the cylindrical structure 42. The cap 58 closes the upper end of the cylindrical structure 42 but has a central circular opening 60, with a diameter of roughly 11 inches, that registers with the vertical flow passage 47 to allow upward discharge of filtered airflows. The upper cap 58 also has a circumferential flange 62 that extends downward from around the periphery of the cap 58. The flange 62 is dimensioned to locate closely about the HEPA filter 52 to center the upper end of the cylindrical structure 42 relative to the upper cap 58.

A vertical rod 64, aligned with the central lengthwise axis of the cylindrical structure 42 and threaded at both ends, allows the caps 54, 58 to be drawn toward one another with threaded fasteners to grip the cylindrical structure 42 and also to mount the VOC filter assembly 30 to the housing 12. The lower end of the rod 64 extends through a central vertical clearance hole in the lower cap 54 and carries a lower nut 66 that can be threaded upward against the bottom face of the lower cap 54. The upper end of the rod 64 extends centrally through the opening 60 of the upper cap 56. A U-shaped horizontal bracket 68 with a length of 15 inches is located above and marginally spaced from the upper cap 58. The upper end of the rod 64 extends through a central clearance hole in the bracket 68 and carries a nut 70 that can be threaded downward against the upper face of the bracket 68. Rotating the nuts 66, 70 effectively tightens the upper and lower caps against the ends of the cylindrical structure 42, securing the filter assembly 30 in its operative orientation. In its operative orientation, the filter assembly 30 receives airflows radially through its HEPA filter 52 and activated-carbon pellets 50 and discharges the filtered flows upward along its central passage 47 and through the central opening 60 of the upper cap 58.

How the VOC filter assembly 30 is installed in the housing 12 will be most apparent from FIG. 1 which provides a schematic cross-section in which dimensions of the components of the VOC filter assembly 30 and surrounding mounting structure are exaggerated and minor details of construction are omitted. A thin horizontal metal plate 72 separates the air intake plenum 26 and the intermediate plenum 32. The separator plate 72 has a circular opening 74 with an 11-inch diameter in which the VOC filter assembly 30 is installed. A worker can access the air intake plenum 26 by partially disassembling the particulate filter assembly 28 or alternatively entering through a removable access panel (not illustrated) mounted to the housing 12. The worker can then orient the VOC filter assembly 30 as apparent in FIG. 1 with the opening 60 of the upper cap 58 registered with the opening 74 of the separator plate 72 and with the rod 64 extending vertically through the opening 74. Another worker can access the intermediate plenum 32 by removing access panels 76 to install the bracket 68 on the rod 64 and mount the upper nut 70 on the rod 64. The nut 70 can then be rotated to draw the filter assembly 30 upward until the upper cap 58 firmly engages the lower face of the separator plate 72. The caps 54, 58 are simultaneously drawn tight about the upper and lower ends of the cylindrical structure 42.

Spent pellets 50 can be replaced periodically. To that end, the filter assembly 30 is removed from the housing 12 by reversing the installation steps described above. With the upper cap 58 removed, the filter assembly 30 is inverted to discharge the pellets 50 from the cavity 48. The filter assembly 30 can then be restored to its operative orientation, and fresh pellets can be poured into the open upper end of the cavity 48. The filter assembly 30 can then be mounted once again to the separator plate 72. In practice, the HEPA filter 52 is unlikely to require replacement as often as spent activated-carbon pellets 50. If replacement is required, the filter assembly 30 may be removed as described above, and delivered to a filter supplier for replacement.

Only a single VOC filter assembly 30 has been shown. In practice, with an intake air flow of roughly 7000 cubic feet of air, three such VOC filter assemblies would be appropriate. The separator plate 72 may be provided with additional circular openings to accommodate the additional filter assemblies.

It will be appreciated that particular embodiments of the invention have been described and that modifications may be made therein, beyond those already suggested, without departing from the scope of claims.

I claim:

1. In a spray booth operated within a building, the spray booth comprising a housing that defines a partially enclosed spray zone in which a worker operates spray equipment that puts particulates and volatiles into the air within the spray zone, a method of controlling air quality within the spray zone, comprising:
drawing a flow of air from the spray zone along a predetermined path through the housing toward a return air port communicating with the interior of the spray zone;
passing the airflow through a filter assembly that removes particulates from the airflow;
passing the particulate-filtered airflow through a filter assembly that removes volatiles from the airflow;
discharging a minor portion of the airflow downstream from the particulate filter assembly to points external to the building; and,
discharging a major portion of the airflow downstream of the volatiles filter assembly through the return air port into the spray zone;
whereby fresh air within the building flows into the spray zone in quantities corresponding to the minor airflow portion.

2. The method of claim 1 in which the volatiles filter assembly releases particulate filter material into the airflow, the method further comprising:
passing the major airflow portion through a plenum located downstream of the volatiles filter assembly and dimensioned to slow the major airflow portion; and,
passing the slowed major airflow portion through filtering material adapted to remove particulates before discharging the major airflow portion into the spray zone.

3. The method of claim 1 further comprising:
using a first airflow producer to draw the airflow from the spray zone along the predetermined path toward the return air port; and,
using a second airflow producer to draw the minor airflow portion from the airflow.

4. A spray booth for use within a building comprising:
a housing defining a partially enclosed spray zone in which a worker can operate spray equipment that puts particulates and volatiles into the air of the spray zone, the housing comprising an air intake port for receiving air from the spray zone, a return air port for discharging air into the spray zone, and means defining a flow path coupling the intake and return air ports;
airflow producing means for drawing airflow from the spray zone through the air intake port and propelling the airflow along the flow path toward the return air port;
particulate filtering means mounted in the flow path to remove particulates entrained with the airflow;
volatiles filtering means mounted in the flow path downstream of the particulate filtering means to remove volatiles entrained with the airflow;
a discharge port associated with the housing and communicating with the flow path downstream of the particulate filtering means to discharge a minor portion of the airflow to points external to the housing and allowing a major portion of the airflow to continue along the flow path toward the return air port;
whereby coupling the discharge port to points external to the building causes fresh air from within the building to flow into the spray zone in quantities corresponding to the minor airflow portion.

5. The spray booth of claim 4 comprising airflow producing means for drawing the minor airflow portion from the airflow.

6. The spray booth of claim 4 in which the volatiles filtering means release particulate filter material into the airflow, the spray booth comprising:
a plenum located in the airflow path downstream of the volatiles filtering means and dimensioned to slow the major airflow portion; and,
filtering material positioned in the flow path to remove the particulate filter material entrained with the slowed airflow.

7. The spray booth of claim 4 in which the volatiles filtering means comprise:
a generally cylindrical structure with an upper end, a lower end and a central lengthwise flow passage extending between the upper and lower ends, the cylindrical structure comprising a pair of generally cylindrical mesh screens with one screen mounted in the other screen so as to define a cylindrical cavity between the screens for receiving pelletized volatile-absorbing filter material, the cavity centered about the central flow passage and the screens permitting flow of air radially through the cavity into the central flow passage, the cavity closed at its lower end to prevent escape of the pelletized filter material under gravity;
lower cap means for closing the lower end of the cylindrical structure against flow of air upward through the lower end of the cylindrical structure; and,
upper cap means for closing the upper end of the cylindrical structure against flow of air upward through the upper end of the cylindrical structure except from the central lengthwise passage.

8. The spray booth of claim 7 in which the generally cylindrical structure comprises a generally cylindrical particulate filter surrounding the outer one of the mesh screens.

9. The spray booth of claim 7 in which:
the upper cap means comprise an opening registered with the flow passage of the generally cylindrical structure;
the flow path comprises an air intake plenum for receiving the particulate-filtered airflow and an upper plenum downstream from the air intake plenum and physically above the air intake plenum, the upper plenum separated from the air intake plenum by a horizontal plate formed with an opening registered with the central flow passage of the generally cylindrical structure;
the particulate filtering means comprise a vertical rod extending along the central flow passage of the cylindrical structure, the rod comprising a lower end portion fastened to the lower cap means and a threaded upper end portion extending upward through the opening of the upper cap means;
a rigid horizontal member abuts an upper face of the horizontal plate and has an aperture through which the threaded upper end portion of the rod extends; and,
a nut is threaded to the threaded upper end portion of the rod and bears against the rigid horizontal member, the nut is rotatable to draw the lower cap means upward until the upper cap means engage a lower face of the horizontal plate.

10. The spray booth of claim 9 in which:
the lower end portion of the rod is threaded and extends through a central opening in the lower cap means; and,
a nut is threaded to the threaded lower end portion of the rod and bears upward against the lower cap means.
